(19) United States
(12) Patent Application Publication
(10) Pub. No.: US 2014/0343915 A1
(43) Pub. Date: Nov. 20, 2014

(54) TEST ENVIRONMENT CONFIGURATION APPARATUS AND METHOD OF OPERATING NETWORK SIMULATION APPARATUS USING SAME

(71) Applicant: ELECTRONICS AND TELECOMMUNICATIONS RESEARCH INSTITUTE, Daejeon-city (KR)

(72) Inventor: Jun-Keun SONG, Daejeon (KR)

(73) Assignee: ELECTRONICS AND TELECOMMUNICATIONS RESEARCH INSTITUTE, Daejeon-city (KR)

(21) Appl. No.: 14/276,188

(22) Filed: May 13, 2014

(30) Foreign Application Priority Data
May 14, 2013 (KR) 10-2013-0054353

(51) Int. Cl. H04L 12/24

(52) U.S. Cl. CPC H04L 41/145
USPC 703/13

(57) ABSTRACT

A test environment configuration apparatus and a method of operating a network simulation apparatus using the test environment configuration apparatus are disclosed. The test environment configuration apparatus includes a scenario configuration module, a simulation initiation module, and a monitoring module. The scenario configuration module configures a simulation scenario performed on one or more virtual machines and one or more simulation nodes generated by a network simulator. The simulation initiation module controls the internal applications of the virtual machines corresponding to the simulation nodes, and generates a simulation initiation signal to run a network simulation for testing a communication connection between the simulation nodes. The monitoring module monitors the network simulation and the internal applications, and provides the results of the monitoring to a user.

### CROSS REFERENCE TO RELATED APPLICATION

This application claims the benefit of Korean Patent Application No. 10-2013-0054353, filed on May 14, 2013, which is hereby incorporated by reference in its entirety into this application.

### BACKGROUND OF THE INVENTION

1. Technical Field

The present invention relates generally to a test environment configuration apparatus and a method of operating a network simulation apparatus using the test environment configuration apparatus and, more particularly, to a method of operating an apparatus, which connects a network simulator and virtual machines using a test environment configuration apparatus and runs a simulation based on the network simulator and virtual machines that are connected to each other.

2. Description of the Related Art

Conventionally, network simulators are used to conduct verification tests prior to the development of network protocols or applications. However, such network simulators are problematic in that they cannot sufficiently reproduce actual network environments. Accordingly, the results of tests performed using the network simulators have low reliability.

Furthermore, a method using a virtual machine has been used as a test method. The test method using a virtual machine is advantageous in that the accuracy of a test is higher than that using a network protocol because code identical to that of an actual network or an application can be implemented and used in the test. However, the test method using a virtual machine is disadvantageous in that a wireless environment cannot be sufficiently reproduced.

Accordingly, research has been carried out into a method of connecting and using a network simulator and a virtual machine. That is, research has been carried out into a method of verifying the operation of a terminal using a virtual machine and verifying a wireless environment using a network simulator. This method of performing a test using both a network simulator and a virtual machine requires the processes of generating and configuring a virtual machine, connecting a network simulator and conducting a test in order to perform a single test. It is inefficient to directly and repeatedly perform these processes on multiple virtual machines and a simulator and then conduct a test. In particular, this method is further inefficient when a large scale experiment, such as an experiment related to a wireless mesh network or a sensor network, is required. Moreover, the method using a network simulator and a virtual machine is disadvantageous in that it is difficult to check the progress of a test.

In this regard, Korean Patent Application Publication No. 2011-0064539 discloses a network simulation apparatus and method using virtual machines.

### SUMMARY OF THE INVENTION

Accordingly, the present invention has been made keeping in mind the above problems occurring in the conventional art, and an object of the present invention is to eliminate inconvenience attributable to the configuration of a network simulation apparatus that is operated by connecting a virtual machine with a network simulator.

Another object of the present invention is to eliminate a problem in which it is difficult to check the progress of a simulation during the simulation, which is a problem of a conventional simulation apparatus.

In accordance with an aspect of the present invention, there is provided a test environment configuration apparatus, including a scenario configuration module configured to configure a simulation scenario performed on one or more virtual machines and one or more simulation nodes generated by a network simulator; a simulation initiation module configured to control the internal applications of the virtual machines corresponding to the simulation nodes, and to generate a simulation initiation signal to run a network simulation for testing a communication connection between the simulation nodes; and a monitoring module configured to monitor the network simulation and the internal applications, and to provide the results of the monitoring to a user.

The monitoring module may monitor data that is sent and received while the network simulation is being run and the internal applications are being controlled.

The monitoring may be activated if the simulation nodes and the virtual machines are connected via the monitoring module; and the monitoring may be deactivated if the simulation nodes and the virtual machines are directly connected.

The simulation initiation module may send the simulation initiation signal to the network simulator and the virtual machines so that the network simulation is run on the simulation nodes and the internal applications are controlled on the virtual machines.

The network simulator and the virtual machines may be separate components, and may operate through separate processes.

The network simulator and the virtual machines may be connected, and may initiate the network simulation and the control of the internal applications based on the simulation scenario.

The simulation initiation module may receive a simulation request from a user, and may generate the simulation initiation signal if the simulation nodes and the virtual machines are connected over a network.

The simulation scenario may include simulation information adapted to include points of time at which the applications are executed and movement of the simulation nodes, numbers of the simulation nodes and the virtual machines used in the simulation, and network establishment information required for connections between the simulation nodes and the virtual machines.

The scenario configuration module may change the simulation information, the numbers of simulation nodes and virtual machines, and the network establishment information.

In accordance with an aspect of the present invention, there is provided a method of operating a network simulation apparatus, including configuring, by a test environment configuration apparatus, a simulation scenario; generating, by a network simulator, one or more simulation nodes bases on the simulation scenario; generating, by a hypervisor, one or more virtual machines corresponding to the simulation nodes based on the simulation scenario; establishing network connections between the network simulator and the virtual machines; generating, by the test environment configuration apparatus, a simulation initiation signal; initiating, by the network simulator, a network simulation for testing a communication connection between the simulation nodes; and controlling, by the virtual machines, the internal applications of the virtual machines.

The operation method may further include monitoring, by the test environment configuration apparatus, data that is sent and received while the network simulation is being run and the internal applications are being controlled.

Monitoring the data may be performed in such a manner that the monitoring is activated if the simulation nodes and the virtual machines are connected via the monitoring module and the monitoring is deactivated if the simulation nodes and the virtual machines are directly connected.

Initiating the network simulation and controlling the internal applications may be performed through separate processes for the network simulator and the virtual machines.

The simulation scenario may include simulation information adapted to include points of time at which the applications are executed and movement of the simulation nodes, numbers of the simulation nodes and the virtual machines used in the simulation, and network establishment information required for connections between the simulation nodes and the virtual machines.

Configuring the simulation scenario may include configuring the simulation scenario by changing the simulation information, the numbers of simulation nodes and virtual machines, and the network establishment information.

Generating the simulation initiation signal may include receiving a simulation request from a user and generating the simulation initiation signal if the simulation nodes and the virtual machine are connected over a network.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a network simulation apparatus according to an embodiment of the present invention;

FIG. 2 is a diagram showing an embodiment of a communication process when a simulation is run using the network simulation apparatus according to the embodiment of the present invention; and

FIG. 3 is a flowchart illustrating the operation of a network simulation apparatus according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

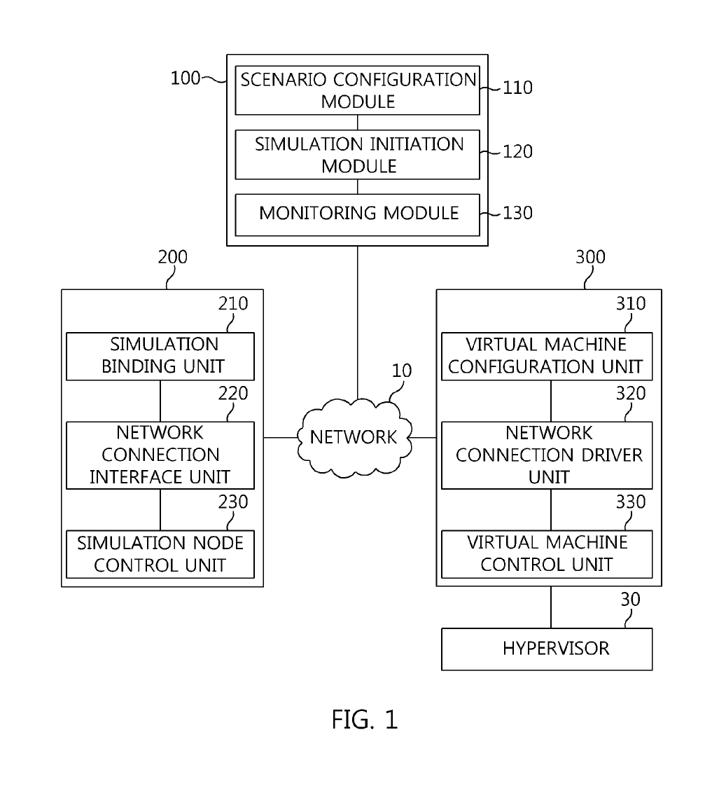

FIG. 1 is a block diagram of a network simulation apparatus 1000 according to an embodiment of the present invention. Referring to FIG. 1, the network simulation apparatus 1000 according to this embodiment of the present invention includes a test environment configuration apparatus 100, a network simulator 200, and a virtual machine 300. The virtual machine 300 functions as a terminal in an actual network environment during a simulation of a network. The components of the network simulation apparatus 1000 are described in detail below. The network simulator 200 and the virtual machine 300 are separate components, and may operate through separate processes. Furthermore, the test environment configuration apparatus 100, the network simulator 200 and the virtual machine 300 may be executed by a processing device in the form of programs. For example, it should be understood that the processing device may include a central processing unit (CPU) and a microcontroller unit (MCU) but is not limited thereto. First, the network simulator 200 functions to run a network simulation of a communication connection between simulation nodes. The network simulator 200 may include a simulation binding unit 210, a network connection interface unit 220, and a simulation node control unit 230. Furthermore, it should be understood that that the simulation binding unit 210, the network connection interface unit 220 and the simulation node control unit 230 may be executed by the above-described processing device but the type of processing device is not limited thereto. The components of the network simulator 200 are described below.

The simulation binding unit 210 functions to generate one or more simulation nodes and to establish a network used in communication with the virtual machine 300 based on a simulation scenario configured by the test environment configuration apparatus 100. That is, the simulation binding unit 210 converts the simulation scenario, configured by the test environment configuration apparatus 100, into a language (e.g., scripts or code) that may be understood by the network simulator 200, and then performs the above function. If a simulation node generated by the network simulator 200 is already present, the already generated simulation node may be used. Furthermore, if the number of already generated simulation nodes is larger than the number of simulation nodes required for a network simulation, the remaining simulation nodes other than a required number of simulation nodes may be deleted.

Furthermore, the establishment of a network performed by the simulation binding unit 210 means the establishment of a network required for communication with the virtual machine 300. Accordingly, for example, the simulation binding unit 210 may perform the network-related configuration of the generated simulation nodes, such as the configuration of IP addresses or a WLAN. That is, the simulation binding unit 210 may function to externally control the operation of the network simulator 200.

The network connection interface unit 220 functions to connect the simulation nodes generated by the simulation binding unit 210 with the virtual machine 300 over a network. Accordingly, network interworking between the simulation nodes and the virtual machine is established. For example, the network interworking may be established by the network 10 of FIG. 1 in a wired or wireless manner. Furthermore, the network interworking may be established using various methods, such as an IPC connection, at a workstation in which the network simulator 200 or a hypervisor 30 operates.

Furthermore, the network connection interface unit 220 may establish a connection with the virtual machine via a TAP bridge.

The simulation node control unit 230 functions to run a network simulation of a communication connection state between the simulation nodes. In this case, the network simulation is initiated when a simulation initiation signal is received from the test environment configuration apparatus 100. The simulation node control unit 230 may run a network simulation through the control of the environment parameters of simulation nodes. For example, it is assumed that an access point (AP) and a plurality of devices connected to the AP and configured to use the Internet are present. In this case, the plurality of devices using the Internet may have different transmission and reception sensitivities depending on various environmental factors, such as the distance to the AP and the presence of an obstacle. Accordingly, the simulation node control unit 230 may conduct a variety of network simulations by configuring the environment parameters in various manners.

The virtual machine 300 functions to control the internal application of the virtual machine 300. In this case, the virtual machine 300 is generated by a hypervisor 30 based on a simulation scenario configured by the test environment configuration apparatus 100. Furthermore, the virtual machine 300 is generated so that it corresponds to a simulation node in a 1:1 correspondence, and is configured to control its internal application. The virtual machine 300 may include a virtual machine configuration unit 310, a network connection driver unit 320, and a virtual machine control unit 330. It should be understood that the virtual machine configuration unit 310, the network connection driver unit 320 and the virtual machine control unit 330 may be executed by the above-described processing device but the type of processing device is not limited to that described in the entire specification, as described above.

Like the simulation binding unit 210, the virtual machine configuration unit 310 functions establish a virtual machine network used in communication with the simulation nodes based on the simulation scenario configured by the test environment configuration apparatus 100.

The network connection driver unit 320 functions to establish network connections with the simulation nodes. That is, the network connection driver unit 320 is used for interworking with the network simulator 200, and may exchange data and control messages with the network simulator 200 or the test environment configuration apparatus 100 over the network 10. The network interworking driver unit 320 may include both wired and wireless drivers. Furthermore, the network connection driver unit 320 may include both a full virtualized driver and a para-virtualized driver.

The virtual machine control unit 330 functions to control the internal application of the virtual machine based on the simulation scenario configured by the test environment configuration apparatus 100. In this case, the internal application is representative of various situations that may occur in connection with the inside of the virtual machine, such as a situation in which a plurality of virtual machines generates traffic at the same time when the plurality of virtual machines interworks with a single AP.

The test environment configuration apparatus 100 is a tool that is connected to the network simulator 200 and the virtual machine 300 and is configured to solve problems occurring while a simulation is being run. That is, the test environment configuration apparatus 100 functions to process a repetitive task in a simulation process. Accordingly, the test environment configuration apparatus 100 configures an environment for access to the network simulator 200 and the hypervisor 30 and an environment for an actual test simulation. More particularly, the test environment configuration apparatus 100 may perform environment configuration, such as the establishment of a network for a simulation node generated by the network simulator 200, the establishment of a network for the virtual machines generated by the hypervisor 30, and the configuration of a network topology.

Furthermore, the test environment configuration apparatus 100 may configure the simulation scenario of a simulation process performed by the network simulation apparatus 1000 of the present invention. In this case, the simulation scenario includes simulation information including a point of time at which an application is executed and a movement of a simulation node, the numbers of simulation nodes and virtual machines used in a simulation, and network establishment information required for the connection between the simulation nodes and the virtual machines. That is, the simulation scenario defines a network simulation performed by the network simulator 200, a plurality of configurations required to control an internal application performed by the virtual machine 300, and the flows of the network simulation and the internal application. Furthermore, the simulation scenario may be stored in a separate storage medium. Accordingly, the generation of a simulation node by the network simulator 200 and the generation of the virtual machine 300 by the hypervisor 30 may be automatically configured, and methods for the network establishment and simulation of a simulation node and the virtual machine 300 may be automatically performed.

In order to perform the above-described functions, the test environment configuration apparatus 100 may include a scenario configuration module 110, a simulation initiation module 120, and a monitoring module 130. It should be understood that the scenario configuration module 110, the simulation initiation module 120 and the monitoring module 130 may be executed by a processing device and the type of processing device is not limited thereto.

The scenario configuration module 110 functions to configure a simulation scenario performed on the virtual machine 300 and a simulation node generated by the network simulator 200. In this case, as described above, the simulation scenario includes simulation information adapted to include a point of time at which an application is executed and the movement of a simulation node, the numbers of simulation nodes and virtual machines used in a simulation, and network establishment information required for the connections between the simulation nodes and the virtual machines. Furthermore, the scenario configuration module 110 may change the simulation information, the numbers of simulation nodes and virtual machines, and the network establishment information. Accordingly, the network simulation and an internal application may be automatically controlled without a direct change to the network simulator 200 and the virtual machine 300 by a user.

The simulation initiation module 120 functions to control the internal application of the virtual machine and to generate a simulation initiation signal for a network simulation that tests the communication connection between simulation nodes. In this case, the simulation initiation module 120 receives a simulation request from a user, and generates a simulation initiation signal when the simulation node and the virtual machine 300 are connected over a network. Thereafter, the simulation initiation module 120 sends the generated simulation initiation signal to the network simulator 200 and the virtual machine 300 so that a network simulation is performed on the simulation node and, at the same time, the internal application of the virtual machine is controlled.

The monitoring module 130 functions to monitor a network simulation and to provide a user with the results of the monitoring. Furthermore, the monitoring module 130 monitors data sent and received during the network simulation, and controls an internal application. Furthermore, if a simulation node and the virtual machine 300 are connected through the monitoring module 130, the monitoring is activated. In contrast, if a simulation node and the virtual machine 300 are directly connected, the monitoring is deactivated.

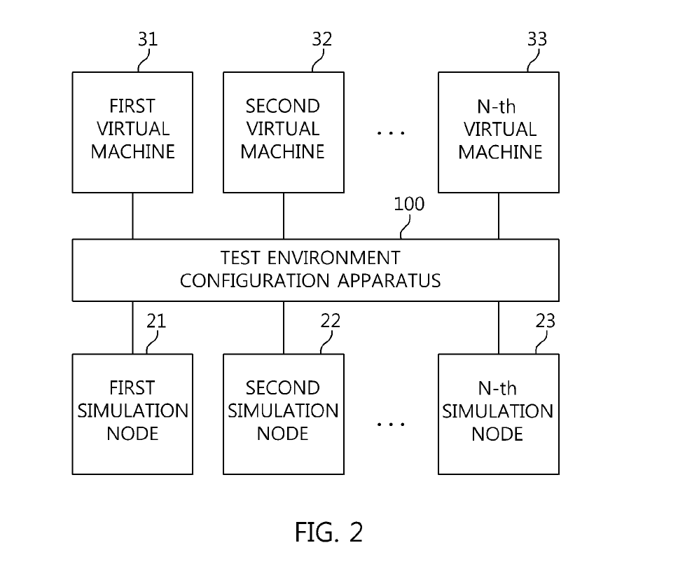

FIG. 2 is a diagram showing an embodiment of a communication process when a simulation is run using the network simulation apparatus according to the embodiment of the present invention. FIG. 2 illustrates a plurality of first to N-th virtual machines 31, 32 and 33, and a plurality of first to N-th simulation nodes 21, 22 and 23. In this case, the virtual machines are associated with the simulation nodes in a 1:1 correspondence. The test environment configuration apparatus 100 allows the first simulation node 21, the second simulation node 22 and the N-th simulation node 23 generated by the network simulator to interwork with the first virtual machine 31, the second virtual machine 32 and the N-th virtual machine 33. As in the embodiment of FIG. 2, when the simulation nodes 21, 22 and 23 and the virtual machines 31, 32 and 33 are connected via the test environment configuration apparatus 100, data may be monitored as described above in conjunction with FIG. 1.

Furthermore, the test environment configuration apparatus 100 may control an internal application or process control messages used in a network simulation in addition to the monitoring. In this case, if the monitoring is not used in response to a request from a user, the simulation nodes 21, 22 and 23 and the virtual machines 31, 32 and 33 may be directly connected and thus direct communication may be performed. In this case, as described above in conjunction with FIG. 1, the simulation nodes 21, 22 and 23 may perform interworking communication with each other through the respective network connection interface units, and the virtual machines 31, 32 and 33 may perform interworking communication with each other via the respective network connection driver units.

For example, it is assumed that the virtual machines 31, 32 and 33 send data. In this case, the data is delivered to the network connection interface units through the test environment configuration apparatus 100. In response thereto, the network simulator checks transmission from a different physical node, and sends the delivered data. Furthermore, a physical layer (not shown) operates through the wireless frequency simulation of the network simulator in the case of a wireless method. In such a simulation, for example, whether or not a signal has been delivered is determined or the intensity of a delivered signal is determined. As described above, in an environment where it is difficult to implement a test, testing can be carried out by simulating the physical layer in the network simulator region.

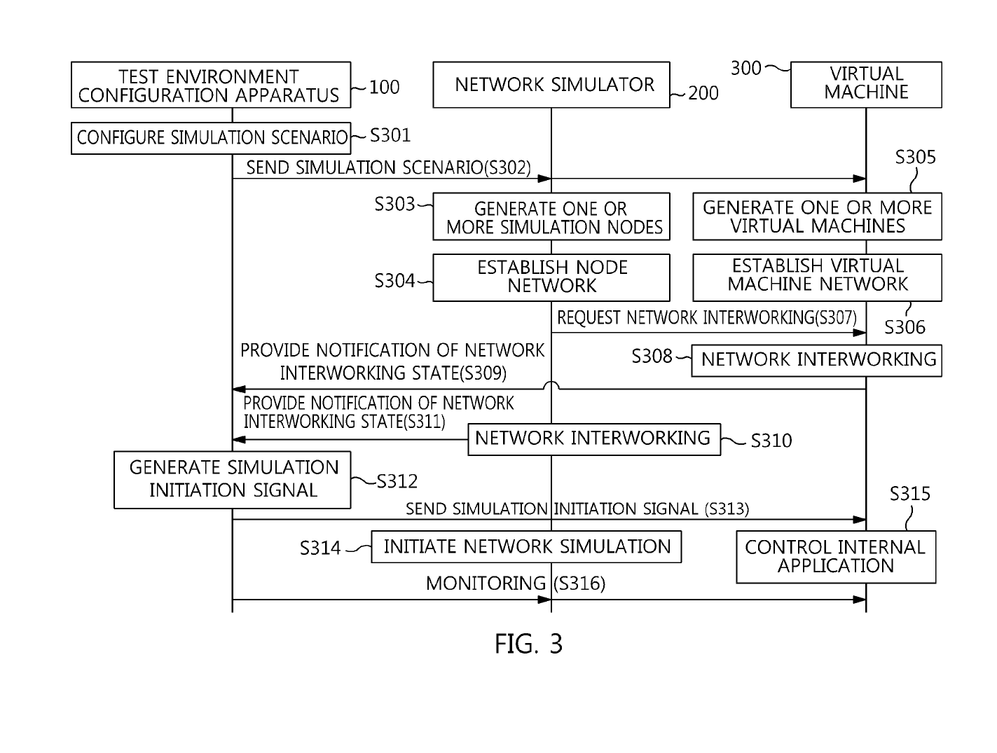

FIG. 3 is a flowchart illustrating the operation of a network simulation apparatus according to an embodiment of the present invention. The descriptions given above in conjunction with FIGS. 1 and 2 are omitted for the clarity of description.

First, the test environment configuration apparatus 100 configures a simulation scenario at step S301. Since the simulation scenario has been described in detail in conjunction with FIG. 1, a detailed description thereof is omitted. At step S301, the simulation scenario may be configured by changing simulation information, the numbers of simulation nodes and virtual machines, and network establishment information.

Thereafter, the simulation scenario is sent to the network simulator 200 and the virtual machine 300 at step S302. Thereafter, control is handed over to steps S303 and S305.

At step S303, the network simulator 200 generates one or more simulation nodes based on the received simulation scenario.

Thereafter, the network simulator 200 establishes a network for the simulation nodes at step S304. In this case, the network for the simulation nodes may be a network, such as an IP address or a WLAN, so that the simulation nodes and the virtual machine 300 are connected as described above.

At step S305, the hypervisor 30 generates one or more virtual machines based on the simulation scenario generated at step S301.

Thereafter, a network for the virtual machines is established at step S306. At step S306, the network for the virtual machines is established to enable interworking between the virtual machines and the network simulator 200, as at step S304.

Thereafter, the network simulator 200 requests network interworking from the virtual machine 300 at step S307. It should be understood that although the network simulator 200 has been described as requesting network interworking at step S307, this is only an example. That is, it should be understood that the virtual machine 300 may request network interworking at step S307 and such a network interworking request may be variable depending on the situation.

Thereafter, network interworking is established between the virtual machine 300 and the network simulator 200 at steps S308 and S310.

Once the network interworking has been established, the network simulator 200 and the virtual machine 300 notify the test environment configuration apparatus 100 of a network interworking state at steps S309 and S311.

Thereafter, the test environment configuration apparatus 100 generates a simulation initiation signal at step S312. At step S312, the test environment configuration apparatus 100 may generate a simulation initiation signal when a simulation request is received from a user and also the simulation nodes and the virtual machines are connected over a network.

Thereafter, the test environment configuration apparatus 100 sends the generated simulation initiation signal to the network simulator 200 and the virtual machine 300 at step S313.

Thereafter, the network simulator 200 initiates a network simulation for testing a communication connection between the simulation nodes at step S314. Furthermore, the virtual machine controls its internal application at step S315. Steps S314 and S315 are performed on the components of the network simulator and the virtual machine through separate processes.

At step S316, the test environment configuration apparatus 100 monitors data sent and received during the network simulation and control of the internal application performed at steps S314 and S315. As described above in conjunction with FIGS. 1 and 2, such a monitoring function is activated when the simulation nodes and the virtual machines are connected through the monitoring module 130 of the test environment configuration apparatus 100. In contrast, if the monitoring function is not required in response to a request from a user, the simulation nodes and the virtual machines may be directly connected without intervention of the monitoring module 130.

As described above, in accordance with the test environment configuration apparatus and the operation method of the network simulation apparatus using the test environment configuration apparatus according to the present invention, when a simulation is conducted through interworking between the network simulator and the virtual machine, repetitive configuration performed in an existing test environment can be eliminated through automation. Accordingly, the test environment configuration apparatus and the operation method of the network simulation apparatus using the test environment configuration apparatus according to the present invention is advantageous in that the time and cost attributable to repetitive tests can be reduced.

Furthermore, the test environment configuration apparatus and the operation method of the network simulation apparatus using the test environment configuration apparatus according to the present invention can prevent an error that may occur due to a user's input error because the same configuration can be provided to the network simulator and the virtual machine using the test environment configuration apparatus.

Moreover, the test environment configuration apparatus and the operation method of the network simulation apparatus using the test environment configuration apparatus according to the present invention are advantageous in that a test bed that is actually difficult to implement can be constructed and an experiment can be conducted on the test bed because a simulation of a physical layer can be conducted through the network simulator.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A test environment configuration apparatus, comprising:
a scenario configuration module configured to configure a simulation scenario performed on one or more virtual machines and one or more simulation nodes generated by a network simulator;
a simulation initiation module configured to control internal applications of the virtual machines corresponding to the simulation nodes, and to generate a simulation initiation signal to run a network simulation for testing a communication connection between the simulation nodes; and
a monitoring module configured to monitor the network simulation and the internal applications, and to provide results of the monitoring to a user.

2. The test environment configuration apparatus of claim 1, wherein the monitoring module monitors data that is sent and received while the network simulation is being run and the internal applications are being controlled.

3. The test environment configuration apparatus of claim 1, wherein:
the monitoring is activated if the simulation nodes and the virtual machines are connected via the monitoring module; and
the monitoring is deactivated if the simulation nodes and the virtual machines are directly connected.

4. The test environment configuration apparatus of claim 1, wherein the simulation initiation module sends the simulation initiation signal to the network simulator and the virtual machines so that the network simulation is run on the simulation nodes and the internal applications are controlled on the virtual machines.

5. The test environment configuration apparatus of claim 1, wherein the network simulator and the virtual machines are separate components, and operate through separate processes.

6. The test environment configuration apparatus of claim 5, wherein the network simulator and the virtual machines are connected, and initiate the network simulation and the control of the internal applications based on the simulation scenario.

7. The test environment configuration apparatus of claim 1, wherein the simulation initiation module receives a simulation request from a user, and generates the simulation initiation signal if the simulation nodes and the virtual machines are connected over a network.

8. The test environment configuration apparatus of claim 1, wherein the simulation scenario comprises simulation information adapted to include points of time at which the applications are executed and movement of the simulation nodes, numbers of the simulation nodes and the virtual machines used in the simulation, and network establishment information required for connections between the simulation nodes and the virtual machines.

9. The test environment configuration apparatus of claim 8, wherein the scenario configuration module changes the simulation information, the numbers of simulation nodes and virtual machines, and the network establishment information.

10. A method of operating a network simulation apparatus, comprising:
configuring, by a test environment configuration apparatus, a simulation scenario;
generating, by a network simulator, one or more simulation nodes bases on the simulation scenario;
generating, by a hypervisor, one or more virtual machines corresponding to the simulation nodes based on the simulation scenario;
establishing network connections between the network simulator and the virtual machines;
generating, by the test environment configuration apparatus, a simulation initiation signal;
initiating, by the network simulator, a network simulation for testing a communication connection between the simulation nodes; and
controlling, by the virtual machines, internal applications of the virtual machines.

11. The operation method of claim 10, further comprising monitoring, by the test environment configuration apparatus, data that is sent and received while the network simulation is being run and the internal applications are being controlled.

12. The operation method of claim 11, wherein monitoring the data is performed in such a manner that the monitoring is activated if the simulation nodes and the virtual machines are connected via the monitoring module and the monitoring is deactivated if the simulation nodes and the virtual machines are directly connected.

13. The operation method of claim 10, wherein initiating the network simulation and controlling the internal applications are performed through separate processes for the network simulator and the virtual machines.

14. The operation method of claim 10, wherein the simulation scenario comprises simulation information adapted to include points of time at which the applications are executed and movement of the simulation nodes, numbers of the simulation nodes and the virtual machines used in the simulation, and network establishment information required for connections between the simulation nodes and the virtual machines.

15. The operation method of claim 14, wherein configuring the simulation scenario comprises configuring the simulation scenario by changing the simulation information, the numbers of simulation nodes and virtual machines, and the network establishment information.

16. The operation method of claim 10, wherein generating the simulation initiation signal comprises receiving a simulation request from a user and generating the simulation initiation signal if the simulation nodes and the virtual machine are connected over a network.
